(19) United States
(12) Patent Application Publication
(10) Pub. No.: US 2007/0208779 A1
(43) Pub. Date: Sep. 6, 2007

(54) Mood Shuffle

(75) Inventor: Gregory Scott Hegstrom, Dublin, OH (US)

Correspondence Address: Gregory Scott Hegstrom, 8048 Townsend Rd., Dublin, OH, 43016, US

(73) Assignee: Gregory Scott Hegstrom, Dublin, OH (US)

(21) Appl. No.: 11/711,072

(22) Filed: Feb. 27, 2007

Related U.S. Application Data
(60) Provisional application No. 60/778,447, filed on Mar. 3, 2006.

(51) Int. Cl. G06F 7/00

(52) U.S. Cl. 707/104.1

(57) ABSTRACT

The invention provides an improved media playback mechanism over using predefined play lists, and random playback modes. Using an individual's personal media library, with associated meta-data, Mood Shuffle identifies the person's current mood in terms of which of their media they wish to experience at the current moment in time. Positive and negative user feedback coaches Mood Shuffle to refine media selection candidates.

### CROSS REFERENCE TO RELATED APPLICATIONS

This application claims the benefit of U.S. provisional patent application Ser. No. 60/778,447, filed Mar. 3, 2006.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention improves upon the standard playback capabilities that media player devices currently possess. Most personal media playing devices/software include playback capabilities with a random playback order, or from predefined subsets of the overall media library, commonly referred to as play-lists. Mood Shuffle removes the need to create predefined play-lists, and significantly improves upon simple random playback modes.

A common example: Often when a person goes to exercise, or do some yard work, they grab their MP3 player, put on their headphones, and then have to make a decision as to what mood they are in, and consequently what media selections they want to play. Often it is not easy to determine what mood we are in, and therefore use the random playback mode as opposed to a predefined play-list. The problem now becomes a continual advancement through selections that are chosen randomly in which we are not currently in the mood to experience.

### BRIEF SUMMARY OF THE INVENTION

Mood Shuffle is a software application that is designed to run on personal media devices such as (but not limited to) a personal computer, or more commonly, a portable device such as an MP3 player.

Mood Shuffle is designed to dynamically discover the person's mood, and choose selections from their media library that they currently want to experience. This is possible because each media selection has specific meta-data associated with it. Some of these include, but are not limited to Genre, Year of Creation, Date of Last Play, Rating, etc. Using this meta-data, combined with the user's playback actions, the Mood Shuffle engine is continually coached, such that it can determine the next selection that will likely be pleasing to the user.

With Mood Shuffle, after a few rounds of coaching, you are left with a subset of media selections from your overall library, that you are currently in the mood to experience.

### BRIEF DESCRIPTION OF THE SEVERAL VIEWS OF THE DRAWING

Not Applicable

### DETAILED DESCRIPTION OF THE INVENTION

A user would start a Mood Shuffle session and be presented with a random media selection that starts playing. The Mood Shuffle engine starts out in a state such that it will not use any meta-data attributes for selection candidate determination, and therefore the initial media selection is chosen at random from the user's entire media library.

Whether the user skips the selection, or chooses to let it play, their choice is used as feedback to determine other media items from their library that will be pleasing to them for this particular playing session.

Mood Shuffle monitors whether a user plays the currently playing selection to completion, or decides to skip it. If the user skips the current media selection, it is considered negative feedback, and a new subset of selection candidates from the overall media library is created, and one is chosen at random from that subset. The selection candidates differ from the skipped selection, based on the meta-data of the skipped selection and the current mood-state. If however the user plays the entire selection, it is considered positive feedback for the current selection, and a new subset of the overall media library is created with choices similar to the current selection. The next selection to be presented is chosen at random from the newly created subset.

This refining process continues to take place throughout the Mood Shuffle session, with the end result being a subset of media selections that coincide with the user's current mood. The user will find the remaining media selections pleasing to experience, in the current moment, without having to continually skip selections that they are not in the mood to experience.

The Mood Shuffle engine uses three different types of meta-data attributes. Character strings, integers, and dates. Each attribute has a weight associated with it, and a threshold. Additionally each attribute has both a positive and negative entry, effectively doubling the number of attributes and associated weights.

An example of a character string attribute would be the artist's name.

An example of an integer attribute would be the number of times a media item has been played.

An example of a date attribute would be the date that the media item was last played.

The positive version of an attribute signifies playing selections that match the attribute, while the negative version of an attribute signifies playing selections that do not match the attribute.

A match is determined by a media selection's attribute being in the range of the corresponding mood engine's attribute plus or minus the associated threshold value unique to each attribute.

If the user feedback is positive, and;
a positive attribute is matched, its weight is increased.
a positive attribute does not match, its weight is decreased.
a negative attribute is matched, its weight is decreased.
a negative attribute is not matched, its weight is increased.

If the user feedback is negative, and;
a positive attribute is matched, its weight is decreased.
a positive attribute is not matched, its weight is increased.
a negative attribute is matched, its weight is increased.
a negative attribute is not matched, its weight is decreased.

The mood engine attributes are then sorted by their weights, and applied to the list of remaining media items in the user's library. Each attribute is compared, in weight-sorted order, to each media selection in the user's library to see if it should remain as a candidate for the next selection. Once the entire list of mood engine attributes has been tested, or the special case of all the selection candidates being eliminated is handled, a media-item is randomly selected from the candidates remaining.

The invention claimed is:

1. A method for dynamic mood determination, using continual user feedback and the meta-data associated with each media item, in order to select and play media from a user's media library, that the user wants to experience at the current point in time.

2. The method of claim 1 wherein the meta data includes artist, genre, date added to Library, date the media item was last played, a user rating, tempo, style, date the media was composed, and album.

3. A mood-state based on the meta-data of claim 2 wherein the mood-state is represented by both positive and negative values for every meta-data item, each with an associated weight value.

4. The method of claim 1 wherein continual user feedback is either positive or negative for the currently playing media item.

5. Positive feedback of claim 4 is determined by a user allowing the current media item to play through to completion.

6. Negative feedback of claim 4 is determined by a user choosing to skip the currently playing media item.

7. The method of claim 1 wherein the initial media item to play is chosen, at random from all of the media items in the user's library.

8. The mood-state of claim 3 wherein the mood-state is initialized by iterating through each un-initialized meta-data item as follows;
If the corresponding meta-data is not initialized, and whether it is positive or negative matches the user feedback, its value is set to the current media item's value, and the initial weight is set to a default value.
If the corresponding meta-data is not initialized, and whether it is positive or negative does not match the user feedback, it is left un-initialized.

9. The mood-state of claim 3 wherein the mood-state is updated by iterating through each initialized meta-data item as follows;
When user feedback matches whether the mood-state meta-data item is positive or negative, the weight is increased if the corresponding values match, and decreased otherwise.
When user feedback does not match whether the mood-state meta-data item is positive or negative, the weight is increased if the corresponding values do not match, and decreased otherwise.

10. The mood-state of claim 3 wherein all of the meta-data is sorted by their weights, and applied in sorted order to all of the yet to be played media items in the user's library as follows;
If a meta-data item is positive, media items that do not match are removed as candidates for the next selection to play.
If a meta-data item is negative, media items that that match are removed as candidates for the next selection to play.

11. The method of claim 10 wherein the media item to play next is chosen randomly from the set of candidates remaining.
